(19) United States
(12) Patent Application Publication
(10) Pub. No.: US 2009/0134777 A1
(43) Pub. Date: May 28, 2009

(54) ELECTRON EMISSION DEVICE AND LIGHT EMISSION APPARATUS INCLUDING THE SAME

(76) Inventors: So-Ra Lee, Suwon-si (KR); Jae-Myung Kim, Suwon-si (KR); Yoon-Jin Kim, Suwon-si (KR); Hee-Sung Moon, Suwon-si (KR); Kyu-Nam Joo, Suwon-si (KR); Hyun-Ki Park, Suwon-si (KR)

Correspondence Address: CHRISTIE, PARKER & HALE, LLP, PO BOX 7068, PASADENA, CA, 91109-7068, US

(21) Appl. No.: 12/166,389

(22) Filed: Jul. 2, 2008

(30) Foreign Application Priority Data
Nov. 28, 2007 (KR) 10-2007-0121993

(51) Int. Cl. H01J 1/62

(52) U.S. Cl. 313/503

(57) ABSTRACT

An electron emission device and a light emission apparatus including the same are provided. The electron emission device and the light emission apparatus including the same have a local dimming capability. The electron emission device includes a substrate; first electrodes spaced apart from one another and extending in a first direction on the substrate; second electrodes disposed between the first electrodes and extending in parallel with the first electrodes; a plurality of third electrodes electrically insulated from the first electrodes and the second electrodes, and extending in a direction crossing the first direction; and first electron emission units and second electron emission units, which are respectively formed on side surfaces of the first electrodes and the second electrodes.

### CROSS-REFERENCE TO RELATED PATENT APPLICATION

This application claims priority to and the benefit of Korean Patent Application No. 10-2007-0121993, filed on Nov. 28, 2007, in the Korean Intellectual Property Office, the disclosure of which is incorporated herein in its entirety by reference.

### BACKGROUND OF THE INVENTION

1. Field of the Invention

The present invention relates to an electron emission device and a light emission apparatus including the same.

2. Description of the Related Art

When light emitted from any apparatus can be detected when viewed from outside, the apparatus is known as a light emission apparatus. In this regard, light emission apparatuses are well known in the art. A light emission apparatus includes an anode and a phosphor layer formed on a top substrate, and an electron emission portion and a driving electrode formed on a bottom substrate. Edges of the top substrate and the bottom substrate are attached to each other by a sealing member. Then, a vacuum is formed in an internal space between the top substrate and the bottom substrate. Thus, the top substrate and the bottom substrate define a vacuum chamber together with the sealing member.

The driving electrode includes a cathode and a gate electrode that are disposed parallel to each other. The electron emission portion may be disposed on a side surface of the cathode, wherein the side surface of the cathode faces the gate electrode. The driving electrode and the electron emission portion constitute an electron emission unit.

The anode is disposed on a first surface of the phosphor layer, wherein the first surface of the phosphor layer faces the bottom substrate. Thus, the anode and the phosphor layer constitute a light emission unit.

The light emission apparatus is driven as follows: a predetermined voltage is applied to the cathode and the gate electrode, and a direct current (DC) voltage (i.e., an anode voltage) of several thousands of volts (V) or more is applied to the anode. Then, an electric field is generated around the electron emission portion due to a voltage difference between the cathode and the gate electrode, and thus electrons are emitted from the electron emission portion. The emitted electrons are attracted by the anode voltage to collide with the corresponding phosphor layer, and thus the phosphor layer emits light.

However, in the above-described light emission apparatus, when the light emission apparatus is driven by applying a predetermined driving voltage to the cathode and the gate electrode, light is concurrently emitted by electron emission devices in all rows and columns. In addition, the cathode and the gate electrode are disposed on the same layer.

### SUMMARY OF THE INVENTION

Embodiments of the present invention provide an electron emission device and a light emission apparatus including the same, which can provide a local dimming capability by including an additional electrode that is insulated from a cathode and a gate electrode.

According to an embodiment of the present invention, there is provided an electron emission device. The electron emission device includes: a substrate; first electrodes spaced apart from one another and extending in a first direction on the substrate; second electrodes between the first electrodes and extending in parallel with the first electrodes; a plurality of third electrodes electrically insulated from the first electrodes and the second electrodes, and extending in a direction crossing the first direction; and first electron emission units and second electron emission units, which are respectively formed on side surfaces of the first electrodes and the second electrodes.

The first electron emission units and the second electron emission units may be spaced from each other.

Each of the first electron emission units and the second electron emission units may have a thickness that is less than a thickness of each of the first electrodes and the second electrodes.

Each of the first electron emission units and the second electron emission units may include carbide-driven carbon.

The plurality of third electrodes may be located on a side of the substrate opposite to another side of the substrate where the plurality of first electrodes and the plurality of second electrodes are located.

According to another embodiment of the present invention, there is provided a light emission apparatus. The light emission apparatus includes a first substrate, a second substrate facing the first substrate, an electron emission unit on a surface of the first substrate, and a light emission unit on the second substrate. The electron emission unit includes a plurality of electron emission devices. Each of the plurality of electron emission devices includes: a plurality of first electrodes spaced apart from one another and extending in a first direction on the first substrate; a plurality of second electrodes between the plurality of first electrodes and extending in parallel with the plurality of first electrodes; a plurality of third electrodes electrically insulated from the plurality of first electrodes and the plurality of second electrodes, and extending in a direction crossing the first direction; a plurality of first electron emission units on side surfaces of the first electrodes; and a plurality of second electron emission units on side surfaces of the second electrodes. The light emission unit includes: a fourth electrode on a surface of the second substrate; and a phosphor layer on a first surface of the fourth electrode. The first surface of the fourth electrode faces the first substrate.

An electron emission device of the plurality of electron emission devices may include a third electrode of the plurality third electrodes. The third electrode is configured to substantially prevent electrons emitted from the first electron emission units and the second electron emission units from traveling toward the light emission unit when a voltage is applied to the third electrode.

An electron emission device of the plurality of electron emission devices may include a third electrode of the plurality of third electrodes. The third electrode is configured to allow electrons emitted from the first electron emission units and the second electron emission units to collide with the phosphor layer to emit visible rays when a voltage is not applied to the third electrode.

The apparatus may further include wirings for supplying currents to the first electrodes and the second electrodes, wherein the wiring are disposed to cross the third electrodes.

The first electron emission units and the second electron emission units may be spaced apart from each other.

Each of the first electron emission units and the second electron emission units may have a thickness that is less than a thickness of each of the first electrodes and the second electrodes.

Each of the first electron emission units and the second electron emission units may include carbide-driven carbon. The plurality of third electrodes may be located on a side of the first substrate opposite to another side of the first substrate where the plurality of first electrodes and the plurality of second electrodes are located.

According to yet another embodiment of the present invention, a light emission apparatus is provided. The light emission apparatus includes: a first substrate; a second substrate facing the first substrate; a first electrode on the first substrate; a second electrode on the first substrate and adjacent to the first electrode; a third electrode electrically insulated from the first electrode and the second electrode; a first electron emission unit on a side surface of the first electrode; a second electron emission unit on a side surface of the second electrode, the second electron emission unit facing the first electron emission unit; and a fourth electrode on a surface of the second substrate. The third electrode is configured to substantially prevent electrons emitted from the first electron emission unit and electrons emitted from the second electron emission unit from reaching the fourth electrode when a voltage is applied to the third electrode.

The third electrode may be located on a side of the first substrate opposite to another side of the first substrate where the first electrode and the second electrode are located.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial cross-sectional view of a light emission apparatus according to an embodiment of the present invention;

FIG. 2 is a perspective view of an electron emission device of the light emission apparatus illustrated in FIG. 1, according to an embodiment of the present invention;

FIG. 3 is a plan view of an electron emission unit of the light emission apparatus of FIG. 1, including a plurality of the electron emission devices illustrated in FIG. 2, according to another embodiment of the present invention; and

FIGS. 4 and 5 are partial cross-sectional views illustrating the light emission apparatus illustrated in FIG. 1 for describing the light emission apparatus as being driven, according to an embodiment of the present invention.

### DETAILED DESCRIPTION OF THE EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

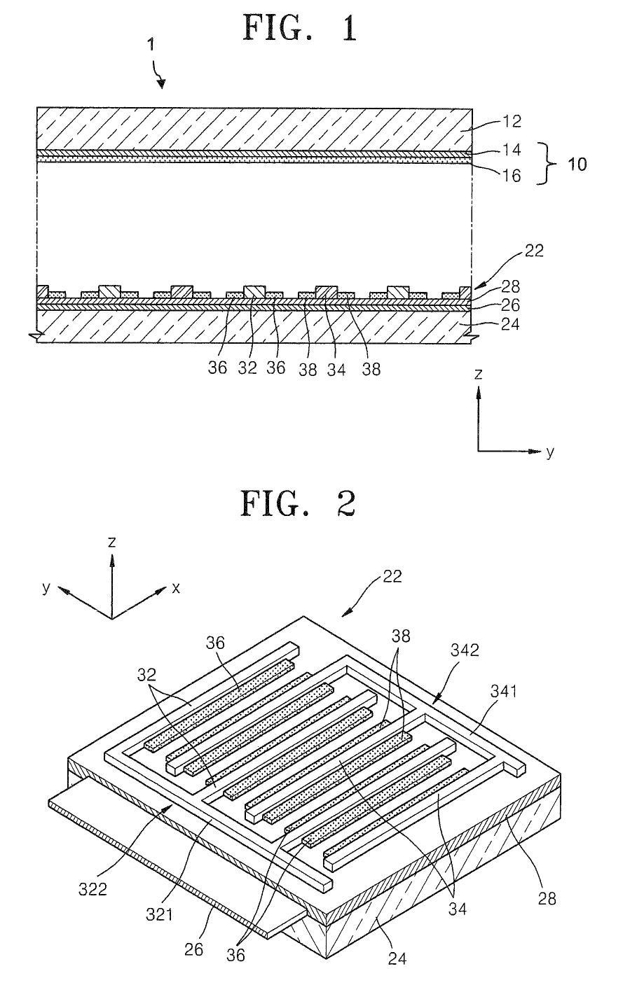

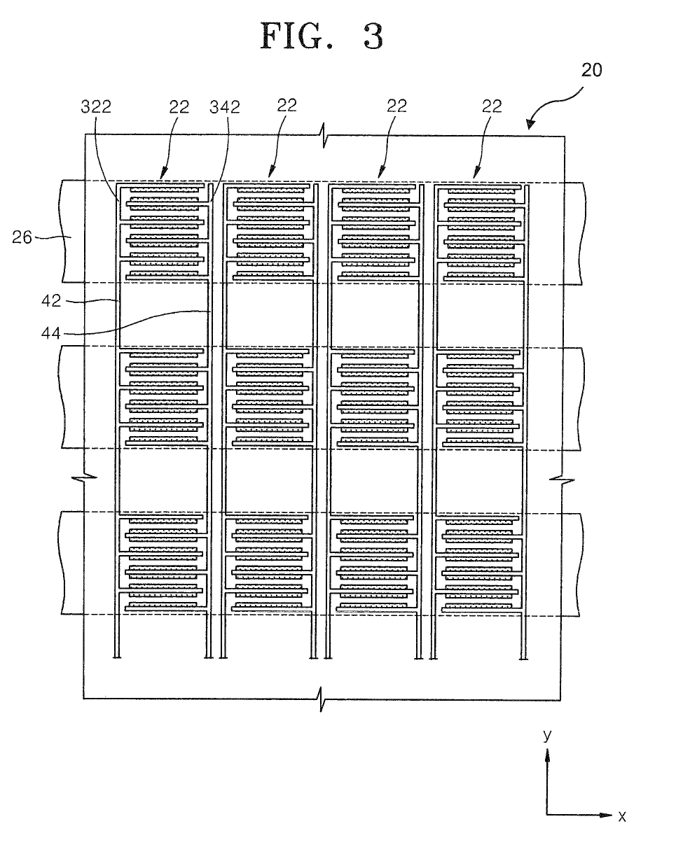

FIG. 1 is a partial cross-sectional view of a light emission apparatus 1 according to an embodiment of the present invention. FIG. 2 is a perspective view of an electron emission device 22 of the light emission apparatus 1 illustrated in FIG. 1, according to an embodiment of the present invention. FIG. 3 is a plan view of an electron emission unit 20 of the light emission apparatus 1 of FIG. 1, including a plurality of the electron emission devices 22, according to another embodiment of the present invention.

Referring to FIGS. 1 through 3, the light emission apparatus 1 includes a first substrate 12 and a second substrate 24, which are spaced apart and disposed parallel to each other. A sealing member (not shown) is disposed on edges of the first substrate 12 and the second substrate 24. Thus, the first and second substrates 12 and 24 are coupled to each other. In addition, the air in an internal space between the first and second substrates 12 and 24 is exhausted to the outside so that a vacuum of 10⁻⁶ torr is formed in the internal space. Thus, the first substrate 12, the second substrate 24 and the sealing member define a vacuum chamber.

The region inside the vacuum chamber on each of the first substrate 12 and the second substrate 24 can be divided into a display region that is actually involved in emitting visible rays, and a non-display region surrounding the display region. The electron emission unit 20 (see FIG. 3) for emitting electrons is disposed on the display region of the second substrate 24. A light emission unit 10 for emitting visible rays is disposed on the display region of the first substrate 12.

The electron emission unit 20 includes a plurality of the electron emission devices 22 of which the emission currents are separately controlled. The light emission unit 10 is disposed on the first substrate 12. When the light emission apparatus 1 operates, the light emission unit 10 receives electrons from the electron emission devices 22 disposed on the second substrate 24 to emit visible rays.

The electron emission unit 20 is configured so to be bipolar driven.

In particular, referring to FIG. 2, the electron emission device 22 includes first electrodes 32 spaced apart from each other (i.e., y-axis direction in FIG. 2) and extending in a first direction (i.e., x-axis direction in FIG. 2) of the second substrate 24, second electrodes 34 disposed between the first electrodes 32, and first electron emission units 36 having a thickness less than that of each of the first electrodes 32 and disposed adjacent to side surfaces of the first electrodes 32, wherein the side surfaces of the first electrodes 32 face the side surfaces of the second electrodes 34. Second electron emission units 38 are disposed on side surfaces of the second electrodes 34, wherein the side surfaces of the second electrodes 34 face the first electrodes 32, such that the thickness of each of the second electron emission units 38 is less than that of each of the second electrodes 34. The first electrodes 32 and the second electrodes 34 are formed to be parallel to one another.

Gaps are formed between the first electron emission units 36 and the second electron emission units 38 so as to prevent electric shorts between the first electron emission units 36 and the second electron emission units 38. Thus, the first electron emission units 36 are spaced apart from the second electron emission units 38 by an interval (e.g., a predetermined distance).

As illustrated in FIG. 2, the first electron emission units 36 and the second electron emission units 38 may each be formed to extend in a direction parallel to the first electrodes 32 in a stripe pattern. Alternatively, although not illustrated in FIGS. 1 through 3, the first electron emission units 36 and the second electron emission units 38 may each be formed to extend in a direction parallel to the first electrodes 32 and the second electrodes 34 in a plurality of patterns which are spaced apart from one another.

Referring to FIG. 2, a first connection electrode 321 is disposed to electrically couple first ends of the first electrodes 32 to one another so as to constitute a first electrode set 322 together with the first electrodes 32. A second connection electrode 341 is disposed to electrically couple first ends of the second electrodes 34 to one another so as to constitute a second electrode set 342 together with the second electrodes 34.

The first electrodes 32 and the second electrodes 34 are formed on the second substrate 24 to each have a greater thickness than that of each of the first and second electron emission units 36 and 38. To achieve this, the first electrodes 32 and the second electrodes 34 may be formed using a thick film process (e.g., screen printing or laminating) or a thin film process (e.g., sputtering or vacuum plating). However, the present invention is not limited thereto, and various other methods may be used for forming the first electrodes 32 and the second electrodes 34.

The first and second electron emission units 36 and 38 may include material (e.g., a carbonaceous-based material or a nanometer-sized material) to which an electric field is applied in a vacuum to emit electrons. For example, the first and second electron emission units 36 and 38 may include a material selected from one of carbon nanotube, graphite, graphite nanofiber, diamond, diamond-like carbon, fullerene (C₆₀), silicon nanowire, or a combination thereof.

In addition, the first and second electron emission units 36 and 38 may include carbide-driven carbon. The carbide-driven carbon can be prepared by using a method in which a carbide compound thermochemically reacts with a halogen-containing gas and elements, except that carbon is extracted from the carbide compound.

The carbide compound may be at least one of SiC₄, B₄C, TiC, ZrCₓ, Al₄C₃, CaC₂, TiₓTa_{y}C, MoₓW_{y}C, TiNₓC_{y} or ZrNₓC_{y}. The halogen-containing gas may be Cl₂, TiCI₄ or F₂. If the first and second electron emission units 36 and 38 include carbide-driven carbon, they have enhanced electron emission uniformity and an increased lifetime.

The first and second electron emission units 36 and 38 may be formed using screen printing for example, but the present invention is not limited thereto. That is, various methods may be used for forming the first and second electron emission units 36 and 38.

The electron emission unit 20 is configured to have a local dimming capability. To achieve this, in one embodiment, the electron emission device 22 includes a third electrode 26. In particular, a plurality of third electrodes 26 are formed on the second substrate 24 to extend in the first direction (i.e., x-axis direction): A dielectric layer 28 is formed on each of the third electrodes 26 so as to electrically insulate the third electrodes 26 from the first electrodes 32 and the second electrodes 34. The first electrodes 32 and the second electrodes 34 are formed on the dielectric layer 28. Local dimming in reference to the third electrodes 26 will be described later.

Referring to FIG. 3, the electron emission devices 22 are disposed on the display region of the second substrate 24 in rows and columns. First wiring portions 42 and second wiring portions 44 are disposed between rows of the electron emission devices 22 to electrically connect adjacent electron emission devices 22 in a column direction, and to apply driving voltages to the first electrodes 32 and the second electrodes 34 of the respective electron emission devices 22.

The first wiring portions 42 each extend in the column direction (i.e., y-axis direction of FIG. 3) on the second substrate 24, and are electrically connected between two corresponding first electrode sets 322 of two adjacent electron emission devices 22 in the column direction. The second wiring portions 44 each extend in a direction (i.e., y-axis direction of FIG. 3) parallel to the first wiring portions 42, and are electrically connected between two corresponding second electrode sets 342 of two adjacent electron emission devices 22 in the column direction.

The first wiring portions 42 and the second wiring portions 44 are separately formed in FIG. 3, but the present invention is not limited thereto. That is, the second electrodes 34 of a first of the electron emission devices 22 may share a connection electrode with the first electrodes 32 of a second of the electron emission devices 22, which is adjacent to the first of the electron emission devices 22. In particular, the second electrodes 34 of the electron emission devices 22 may be formed from a left side of the connection electrode, and concurrently, the first electrodes 32 of the electron emission devices 22 may be formed from a right side of the connection electrode. That is, the connection electrode can function as the second connection electrode 341 of a first of the electron emission devices 22, and concurrently can function as the first connection electrode 321 of a second of the electron emission devices 22, which is adjacent to the first of the electron emission devices 22. Accordingly, wiring portions connected to the connection electrode are not divided into the first and second wiring portions 42 and 44, and can be common to the first electrodes 32 and the second electrodes 34 of two adjacent electron emission devices 22, respectively.

Referring back to FIG. 1, the light emission unit 10 includes a fourth electrode 14 and a phosphor layer 16. The fourth electrode 14 is formed on a surface of the first substrate 12 that faces the second substrate 24. The phosphor layer 16 is formed on a surface of the fourth electrode 14 that faces the second substrate 24.

The phosphor layer 16 may be formed of a mixed phosphor including a red phosphor, a green phosphor and a blue phosphor, which emits white light, and may be disposed on the entire display region of the first substrate 12. The fourth electrode 14 receives power from a power source outside the vacuum chamber to function as an anode electrode.

The fourth electrode 14 may be formed of a transparent conductive material such as indium tin oxide (ITO) so as to transmit visible rays emitted from the phosphor layer 16.

The fourth electrode 14 may be formed of aluminum to have a thickness of several angstroms, and may include micro-holes for transmitting electron beams therethrough.

Spacers (not shown) may be disposed between the first substrate 12 and the second substrate 24 so as to withstand a pressure applied to the vacuum chamber, and maintain a predetermined distance between the first substrate 12 and the second substrate 24.

With regard to the light emission apparatus 1 having the above-described structure, according to one embodiment, a pixel is defined by one of the electron emission devices 22 and a portion of the phosphor layer 16 corresponding to the electron emission device 22. The light emission apparatus 1 is driven as follows: a scan drive voltage is applied to one of the first wiring portions 42 and the second wiring portions 44; a data drive voltage is applied to the other of the first wiring portions 42 and the second wiring portions 44; an address voltage is applied to the third electrodes 26; and a direct current (DC) voltage (i.e., an anode voltage) of 10 kV or more is applied to the fourth electrode 14.

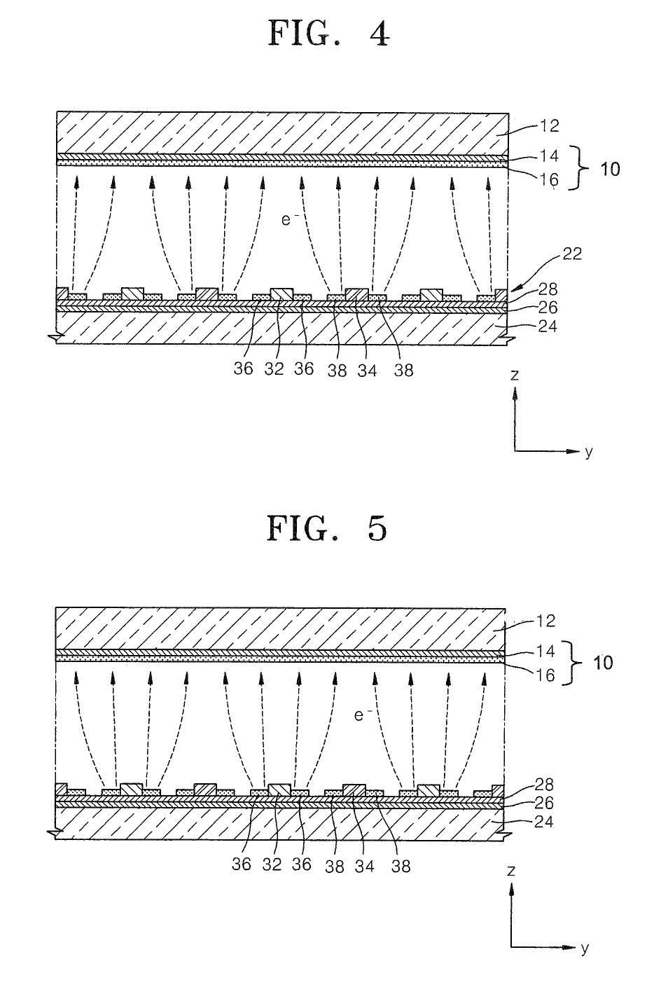

Then, an electric field is generated around the first and second electron emission units 36 and 38 in pixels in which a voltage difference between the first electrodes 32 and the second electrodes 34 is greater than or equal to a critical value, and thus electrons (indicated by e⁻ in FIGS. 4 and 5) are emitted from the first and second electron emission units 36 and 38. At this time, electrons emitted from regions of the first and second electron emission units 36 and 38, to which the address voltage is not applied, are attracted by the anode voltage applied to the fourth electrode 14 to collide with the corresponding phosphor layer 16, and thus the phosphor layer 16 emits light. Visible rays emitted from the phosphor layer 16 are transmitted through the first substrate 12.

FIGS. 4 and 5 are partial cross-sectional views illustrating the light emission apparatus 1 illustrated in FIG. 1 for describing a case when the light emission apparatus 1 is driven, according to an embodiment of the present invention.

According to the present embodiment, in the light emission apparatus 1, a scan driving voltage and a data driving voltage are alternately and repeatedly applied to the first electrodes 32 and the second electrodes 34, respectively. In this regard, one of the first electrodes 32 and the second electrodes 34, to which a low voltage is applied, constitute cathodes, and the other of the first electrodes 32 and the second electrodes 34, to which a high voltage is applied, constitute gate electrodes.

In the light emission apparatus 1, the scan driving voltage may be applied to the first electrodes 32 through the first wiring portions 42, and the data driving voltage may be applied to the second electrodes 34 through the second wiring portions 44, for example, in a time interval “t1”. Then, in the light emission apparatus 1, the scan driving voltage may be applied to the second electrodes 34 through the second wiring portions 44, and the data driving voltage may be applied to the first electrodes 32 through the first wiring portions 42, for example, in a time interval “t2”.

When the scan driving voltage is greater than the data driving voltage, in the time interval “t1”, the second electrodes 34 constitute cathodes, and electrons (indicated by e⁻ in FIG. 4) are emitted from the second electron emission units 38. In the time interval “t2”, the first electrodes 32 constitute cathodes, and electrons (indicated by e⁻ in FIG. 5) are emitted from the first electron emission units 36.

By alternately and repeatedly driving the first electron emission units 36 and the second electron emission units 38 as shown in the time intervals “t1” and “t2”, electrons can be alternately emitted from the first electron emission units 36 and the second electron emission units 38. Using such a bipolar driving method, loads applied to the first and second electron emission units 36 and 38 are reduced, therefore the lifetime of the first and second electron emission units 36 and 38 can be increased, and the brightness of emissive surfaces of the first and second electron emission units 36 and 38 can be increased.

According to the described embodiment, the electron emission unit 20 includes the third electrodes 26 for local dimming. In particular, when an address voltage is applied to the third electrodes 26, electrons emitted from the first and second electron emission units 36 and 38 respectively driven by the first electrodes 32 and the second electrodes 34, are attracted by the electron emission device 22 rather than traveling towards the phosphor layer 16 of the light emission unit 10, therefore the light emission unit 10 cannot emit light. On the other hand, when an address voltage is not applied to the third electrodes 26, electrons emitted from the first and second electron emission units 36 and 38, respectively driven by the first electrodes 32 and the second electrodes 34, collide with a part of the phosphor layer 16 corresponding to the first and second electron emission units 36 and 38, and the light emission unit 10 emits light.

That is, when one of the scan and data driving voltages is applied to the first electrodes 32 through the first wiring portions 42 of the electron emission unit 20, and the other of the scan and data driving voltages is applied to the second electrodes 34 through the second wiring portions 44, electrons are alternately emitted from the first electron emission units 36 of the first electrode set 322 connected to the first wiring portions 42, and the second electron emission units 38 of the second electrode set 342 connected to the second wiring portions 44. Here, in a row including one of the third electrodes 26 in the case where the address voltage is applied to the third electrode 26, the emitted electrons do not travel toward the phosphor layer 16 of the light emission unit 10 due to the address voltage applied to the third electrode 26, therefore the light emission unit 10 cannot emit light. On the other hand, in another row including one of the third electrodes 26 in the case where the address voltage is not applied to the third electrode 26, the emitted electrons are attracted by an anode voltage to collide with the corresponding part of the phosphor layer 16, therefore the phosphor layer 16 can emit light.

That is, in order to select the electron emission devices 22 to emit no light, voltages are applied to the first electrodes 32 and the second electrodes 34 of the electron emission devices 22 in a column (i.e., y-axis direction in FIG. 3) to emit electrons from the corresponding first and second electron emission units 36 and 38, and concurrently voltages are applied to the third electrode 26 of a row (i.e., x-axis direction in FIG. 3) of the electron emission devices 22 to prevent the emitted electrons from traveling toward and colliding with the corresponding phosphor layer 16, thereby emitting no light. Thus, an electron emission device having a local dimming capability, and a light emission apparatus including the same are provided.

The thicknesses of the first and second electron emission units 36 and 38 are respectively less than those of the first electrodes 32 and the second electrodes 34. In particular, the thickness of each of the first electron emission units 36 is less than that of each of the first electrodes 32 by about 1 through 10 μm, and the thickness of each of the second electron emission units 38 is less than that of each of the second electrodes 34 by 1 through 10 μm. When a thickness difference between the first and second electrodes 32 and 34 and the first and second electron emission units 36 and 38, respectively, is 1 μm or less, the shielding effect of an anode electric field is reduced. Thus, high voltage stability is reduced, and accordingly the brightness, efficiency and lifetime of the light emitting apparatus 1 cannot be improved. When the thickness difference between the first and second electrodes 32 and 34 and the first and second electron emission units 36 and 38, respectively, is 10 μm or more, a driving voltage can be increased due to an increased distance between the first and second electrodes 32 and 34 and the first and second electron emission units 36 and 38, respectively.

In the above-described structure, electric fields around the first and second electron emission units 36 and 38 vary according to voltages applied to the first electrodes 32 and the second electrodes 34 which are formed on the second substrate 24 with thicknesses greater than the first and second electron emission units 36 and 38, respectively, and thus the effect of the anode electric fields is reduced with respect to the first and second electron emission units 36 and 38. Thus, even when an anode voltage of 10 kV or more is applied to the fourth electrode 14 in order to increase the brightness of an emissive surface of the light emission apparatus 1, the first electrodes 32 and the second electrodes 34 reduce anode electric fields around the first and second electron emission units 36 and 38. Thus, diode emission can be prevented due to anode electric fields.

In the light emission apparatus 1, when an anode voltage is increased, the brightness of the emissive surface of the light emission apparatus 1 can be increased. In addition, diode emission can be prevented, and brightness can be accurately controlled for each pixels. Accordingly, the light emission apparatus 1 has increased high voltage stability, therefore arcing occurrence in the vacuum chamber is minimized, and damage of an inner structure of the light emission apparatus 1 due to the arcing can be prevented.

According to the embodiments of the present invention, an electron emission device having a local dimming capability and a light emission apparatus including the electron emission device are provided.

According to the embodiments of the present invention, in the electron emission device having a local dimming capability and the light emission apparatus including the same, the electron emission portions face each other, and the electron emission portions can be bipolar driven, therefore the lifetime and brightness of the electron emission portions can be increased.

According to the embodiments of the present invention, in the electron emission device and the light emission apparatus including the same, by patterning a photo paste including carbide-driven carbon as a material used for forming the electron emission portions, unstable emission performance can be overcome, and a structure having a simple cold negative pole can be obtained compared with a conventional structure having a cold negative pole.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An electron emission device comprising:
a substrate;
a plurality of first electrodes spaced apart from one another and extending in a first direction on the substrate;
a plurality of second electrodes between the plurality of first electrodes and extending in parallel with the plurality of first electrodes;
a plurality of third electrodes electrically insulated from the plurality of first electrodes and the plurality of second electrodes, and extending in a direction crossing the first direction; and
a plurality of first electron emission units and a plurality of second electron emission units respectively located adjacent to side surfaces of the plurality of first electrodes and the plurality of second electrodes.

2. The device of claim 1, wherein the first electron emission units and the second electron emission units are spaced from each other.

3. The device of claim 1, wherein each of the plurality of first electron emission units and the plurality of the second electron emission units has a thickness that is less than a thickness of each of the plurality of first electrodes and the plurality of second electrodes.

4. The device of claim 1, wherein each of the plurality of first electron emission units and the plurality of second electron emission units comprises carbide-driven carbon.

5. The device of claim 1, wherein the plurality of third electrodes are located on a side of the substrate opposite to another side of the substrate where the plurality of first electrodes and the plurality of second electrodes are located.

6. A light emission apparatus comprising:
a first substrate;
a second substrate facing the first substrate;
an electron emission unit on a surface of the first substrate, the electron emission unit comprising a plurality of electron emission devices, each of the plurality of electron emission devices comprising:
a plurality of first electrodes spaced apart from one another and extending in a first direction on the first substrate;
a plurality of second electrodes between the plurality of first electrodes and extending in parallel to the plurality of first electrodes;
a plurality of third electrodes electrically insulated from the plurality of first electrodes and the plurality of second electrodes, and extending in a direction crossing the first direction;
a plurality of first electron emission units on side surfaces of the first electrodes; and
a plurality of second electron emission units on side surfaces of the second electrodes; and
a light emission unit comprising:
a fourth electrode on a surface of the second substrate; and
a phosphor layer on a first surface of the fourth electrode,
wherein the first surface of the fourth electrode faces the first substrate.

7. The apparatus of claim 6,
wherein an electron emission device of the plurality of electron emission devices comprising a third electrode of the plurality of third electrodes, and
wherein the third electrode is configured to substantially prevent electrons emitted from the plurality of first electron emission units and the plurality of second electron emission units from traveling toward the light emission unit when a voltage is applied to the third electrode.

8. The apparatus of claim 6,
wherein an electron emission device of the plurality of electron emission devices comprising a corresponding third electrode of the plurality of third electrodes, and
wherein the third electrode is configured to allow electrons emitted from the first electron emission units and the second electron emission units to collide with the phosphor layer to emit visible rays when a voltage is not applied to the third electrode.

9. The apparatus of claim 6, further comprising a plurality of wirings for supplying currents to the first electrodes and the second electrodes, wherein the plurality of wirings cross the plurality of third electrodes.

10. The apparatus of claim 6, wherein the plurality of first electron emission units and the plurality of second electron emission units are spaced from each other.

11. The apparatus of claim 6, wherein each of the plurality of first electron emission units and the plurality of second electron emission units has a thickness that is less than a thickness of each of the plurality of first electrodes and the plurality of second electrodes.

12. The apparatus of claim 6, wherein each of the plurality of first electron emission units and the plurality of second electron emission units comprise carbide-driven carbon.

13. The apparatus of claim 6, wherein the plurality of third electrodes are located on a side of the first substrate opposite to another side of the first substrate where the plurality of first electrodes and the plurality of second electrodes are located.

14. A light emission apparatus comprising:
a first substrate;
a second substrate facing the first substrate;
a first electrode on the first substrate;
a second electrode on the first substrate, the second electrode spaced apart from the first electrode;
a third electrode electrically insulated from the first electrode and the second electrode;
a first electron emission unit on a side surface of the first electrode;
a second electron emission unit on a side surface of the second electrode, the second electron emission unit facing the first electron emission unit; and
a fourth electrode on a surface of the second substrate,
wherein the third electrode is configured to substantially prevent electrons emitted from the first electron emission unit and electrons emitted from the second electron emission unit from reaching the fourth electrode when a voltage is applied to the third electrode.

15. The apparatus of claim 14, wherein each of the first electron emission unit and the second electron emission unit has a thickness that is less than a thickness of each of the first electrode and the second electrode.

16. The apparatus of claim 14, wherein the first electron emission unit and the second electron emission unit comprise carbide-driven carbon.

17. The apparatus of claim 14 wherein the third electrode is located on a side of the first substrate opposite to another side of the first substrate where the first electrode and the second electrode are located.
